(19) United States
(12) Patent Application Publication
(10) Pub. No.: US 2026/0002566 A1
(43) Pub. Date: Jan. 1, 2026

(54) BEARING DEVICE WITH INTEGRATED ELECTRIC INSULATION, IN PARTICULAR FOR AN ELECTRIC MACHINE OR MOTOR

(71) Applicant: AKTIEBOLAGET SKF, GOTEBORG (SE)

(72) Inventors: Mickael CHOLLET, Joué-Lès-Tours (FR); Anthony SIMONIN, Tours (FR); Benoit ARNAULT, Saint-Cyr-sur-Loire (FR)

(21) Appl. No.: 19/235,701

(22) Filed: Jun. 12, 2025

(30) Foreign Application Priority Data
Jun. 26, 2024 (FR) 2406853

(51) Int. Cl. F16C 41/00; F16C 19/06

(52) U.S. Cl. CPC F16C 41/002; F16C 19/06; F16C 2380/26

(57) ABSTRACT

A bearing device includes first and second rings, a bushing and an electrically insulating insert overmolded between and connecting a cylindrical surface of the bushing and a cylindrical surface of the second ring. A connecting chamfer connects one cylindrical surface of the bushing to a front face of the busing, and the connecting chamfer includes a first convex surface extending from the cylindrical surface of the bushing and having a first radius of curvature, a second convex surface extending from the front surface of the bushing and having a second radius of curvature and a first frustoconical surface extending between and connecting the first convex surface to the second convex surface. The first convex surface meets the first cylindrical surface at a first sharp edge, and the first convex surface meets the first front face of the bushing at a second sharp edge.

### CROSS-REFERENCE

This application claims priority to French patent application no. 2406853 filed on Jun. 26, 2024, the contents of which are fully incorporated herein by reference.

### TECHNOLOGICAL FIELD

The present disclosure relates to the field of bearings that are used in particular in electric motors, electric machines and associated equipment.

### BACKGROUND

In an electric machine or motor, at least one rolling bearing is mounted between the housing of the electric machine or motor and the rotary shaft in order to support this shaft. In operation, when the shaft is rotating, a difference in electric potential may arise between the shaft and the housing of the electric machine or motor, generating an electric current between the inner ring of the rolling bearing which is connected to the shaft, and the outer ring which is connected to the housing. The electric current passing through the components of the rolling bearing may damage these components, in particular the rolling elements and the raceways formed in the inner and outer rings. The electric shocks may also cause vibrations.

To remedy these drawbacks, it is known to replace the rolling elements of the bearing that are made from the same steel as that of the inner and outer rings with rolling elements made of ceramic. This kind of bearing is generally referred to as a hybrid rolling bearing. However, such a hybrid rolling bearing is relatively expensive.

To remedy the abovementioned drawbacks, it is also known to equip the outer ring of the rolling bearing with an insulating sleeve provided with a bushing and with an insulating insert made of an electrically insulating material and interposed radially between the outer ring and the bushing. While this bearing device is being mounted inside the housing of the motor or removed therefrom, the bore of the housing may be damaged.

### SUMMARY

The present disclosure aims to remedy this drawback. The disclosure relates to a bearing device comprising a bearing provided with a first ring and a second ring that are configured to rotate with respect to one another.

The device also comprises at least one insulating sleeve mounted on the second ring of the bearing. The insulating sleeve includes a bushing and an insulating insert that is interposed radially between the second ring of the bearing and the bushing. The insulating insert is made of electrically insulating material. The bushing comprises a cylindrical outer surface and a cylindrical inner surface on the opposite side from the outer surface which delimit the radial thickness of the bushing. The bushing also comprises first and second front faces that delimit the axial length of the bushing. The insulating insert is fastened to the second ring of the bearing and at least to one of the outer and inner surfaces of the bushing.

According to a general feature, a first connecting chamfer connects the first front face of the bushing to the first front face of the bushing.

The first connecting chamfer has a first convex surface extending from the cylindrical outer surface that has a first radius of curvature and forms a sharp edge with the cylindrical outer surface. The first connecting chamfer also has a second convex surface extending from a first one of the front faces that has a second radius of curvature and forms a sharp edge with the first one of the front faces. A first frustoconical surface connects the first convex surface to the second convex surface. This results in a bearing device with integrated electric insulation that is economical compared with conventional hybrid rolling bearings.

Furthermore, the device is easy to fit in the associated electric machine or motor without there being a risk of the bore of the electric motor or machine being damaged, given the existence of the first connecting chamfer with a truncated shape.

Each sharp edge forms a change of slope between the first connecting chamfer and the other surface of the bushing, or between the first connecting chamfer and the first front face of the bushing. The slope of each of the convex surfaces varies continuously over its respective length but changes discontinuously at the corner where the convex surfaces meet the cylindrical outer surface or planar front surfaces.

The frustoconical surface of the first connecting chamfer reduces the protruding nature of each of the sharp edges.

Preferably, the first and second radii of curvature have different centers but the same length. Alternately, the lengths can be different.

Preferably, a second connecting chamfer connects the cylindrical outer surface of the bushing to the second front face of the busing.

The second connecting chamfer has a third convex surface extending from the cylindrical outer surface that has a third radius of curvature and forms a sharp edge with the cylindrical outer surface. The second connecting chamfer also has a fourth convex surface extending from the second one of the front faces that has a fourth radius of curvature and forms a sharp edge with the second one of the front faces. A second frustoconical surface connects the third convex surface to the fourth convex surface. This results in a bearing device with integrated electric insulation that is economical compared with conventional hybrid rolling bearings.

Preferably, the third and fourth radii of curvature have different centers but the same length. Alternately, the lengths can be different.

Advantageously, the bushing is made of metal material. The bushing may, for example, be obtained by pressing or by machining.

Preferably, the insulating insert is overmolded on the second ring of the bearing and at least on the surface of the bushing. Alternatively, the insulating insert may be fastened by any other appropriate means, for example by adhesive bonding.

If the insulating insert is made of synthetic material or elastomer material, this makes the device less sensitive to variations in temperature.

In one embodiment, the insulating insert covers the whole of the surface of the bushing. In this case, the insulating insert entirely covers the surface of the bushing in the axial direction and in the circumferential direction.

The expression “axial direction” means the direction parallel to the axis of the bearing device.

The expression “circumferential direction” means the direction which is perpendicular both to the axial direction and to a radius of the bearing device, in other words tangent to a circle the center of which is on the axis of the bearing device.

According to a first design, the bushing delimits the outer surface of the device. In this case, the second ring is the outer ring of the bearing. According to an alternative second design, the bushing delimits the inner surface of the device. In this case, the second ring is the inner ring of the bearing.

In a particular embodiment, the bearing comprises at least one row of rolling elements disposed between raceways of the first and second rings. The rolling elements may be made of metal material.

The disclosure also relates to an electric motor comprising a housing, a shaft and at least one bearing device as defined above and mounted radially between the housing and the shaft.

The disclosure also relates to a method for manufacturing a bushing of a bearing device as defined above, comprising the following successive steps: a step of producing a bushing blank that gives it its basic geometry, a heat treatment step for giving the bushing blank the required hardness, a step of radially grinding the first front face of the bushing blank and a part of the second concave radius of the first connecting chamfer which is adjacent to the first front face, and a step of axially grinding the other surface of the bushing blank and a part of the first concave radius of the first connecting chamfer which is adjacent to the other surface.

The expression “radial direction” means the direction along a radius of the bearing device, i.e. any direction that intersects the axis of the bearing device and is perpendicular to that axis.

### BRIEF DESCRIPTION OF THE DRAWINGS

The present disclosure will be understood better from studying the detailed described of an embodiment, which is given by way of entirely non-limiting example and is illustrated in the appended drawings, in which:

FIG. 1 is an axial sectional view of a bearing device according to an exemplary embodiment of the disclosure which device includes a bushing.

FIG. 2 is a detail view of a first portion of the bushing of the device of FIG. 1.

FIG. 3 is a detail view of a second portion of the bushing of the device of FIG. 1.

FIG. 4 is a perspective view of the bushing of the device of FIG. 1.

FIG. 5 is a detail view of a first portion of the bushing of the device from FIG. 1 showing a section of the surface before grinding in dashed lines and after griding in solid lines.

FIG. 6 is a detail view of a second portion of the bushing of the device from FIG. 1 showing a section of the surface before grinding in dashed lines and after griding in solid lines.

### DETAILED DESCRIPTION

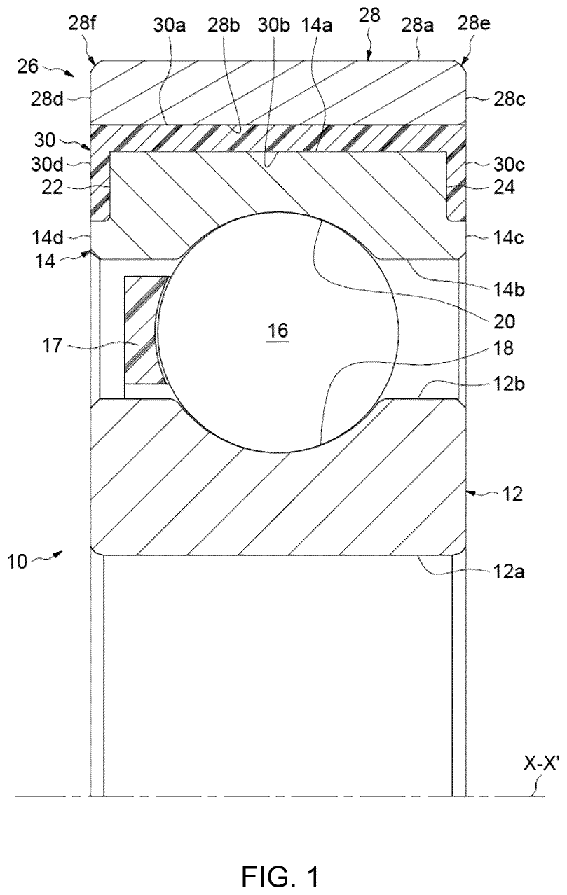

The bearing device illustrated in FIG. 1 comprises a bearing 10 having a first ring 12 and a second ring 14 that are configured to rotate with respect to one another about the axis X-X′ of the bearing. In the exemplary embodiment illustrated, the first ring 12 is the inner ring of the bearing and the second ring 14 is the outer ring.

The bearing device has been designed so as not to conduct electric currents. The bearing device has integrated electric insulation.

The inner ring 12 and outer ring 14 of the bearing are concentric and extend axially along the axis X-X′ of the bearing. The inner ring 12 and outer ring 14 are made of steel. The rings are of the solid type.

In the exemplary embodiment illustrated, the bearing 10 also comprises a row of rolling elements 16, in this case balls, that are interposed radially between the inner ring 12 and outer ring 14. The rolling elements 16 are made of steel. The bearing 10 also comprises a cage 17 for maintaining the regular circumferential spacing of the rolling elements 16. The bearing 10 may also be equipped with seals or flange gaskets.

The inner ring 12 has a cylindrical bore 12a, a cylindrical axially extending outer surface 12b radially on the opposite side from the bore, and two opposite radially extending front faces (not referenced) that axially delimit the bore and the outer surface. The bore 12a and the outer surface 12b delimit the radial thickness of the inner ring 12. The bore 12a forms the inner surface of the inner ring. The inner ring 12 also comprises an inner raceway 18 for the rolling elements 16, which is formed on the outer surface 12b. The raceway 18 is directed radially towards the outside.

The outer ring 14 has a cylindrical axially extending outer surface 14a, a cylindrical bore 14b radially on the opposite side from the outer surface 14a, and two opposite radially extending front faces 14c, 14d that axially delimit the bore. The outer surface 14a and the bore 14b delimit the radial thickness of the outer ring 14. The bore 14b has a stepped shape. The outer ring 14 also comprises an outer raceway 20 for the rolling elements 16, which is formed on the bore 14b. The raceway 20 is directed radially towards the inside.

In the exemplary embodiment illustrated, a groove 22 is formed in the front face 14d of the outer ring. The groove 22 is oriented and open axially towards the outside of the outer ring. The groove 22 has a bottom which is offset axially towards the inside of the ring with respect to the front face 14d. The bottom of the groove 22 forms a shoulder. The bottom of the groove 22 extends radially in this case for reasons of ease of manufacture. The groove 22 is annular in this case.

Similarly, a groove 24 is formed in the front face 14c of the outer ring. The groove 24 is oriented and open axially towards the outside of the outer ring. The groove 24 has a bottom which is offset axially towards the inside of the ring with respect to the front face 14c. The bottom of the groove 24 forms a shoulder. The bottom of the groove 24 extends radially in this case. The groove 24 is annular in this case. The grooves 22, 24 are mutually symmetric with respect to a radial midplane of the outer ring. The grooves 22, 24 axially delimit the outer surface 14a. Alternatively, it could be possible to omit the grooves 22, 24.

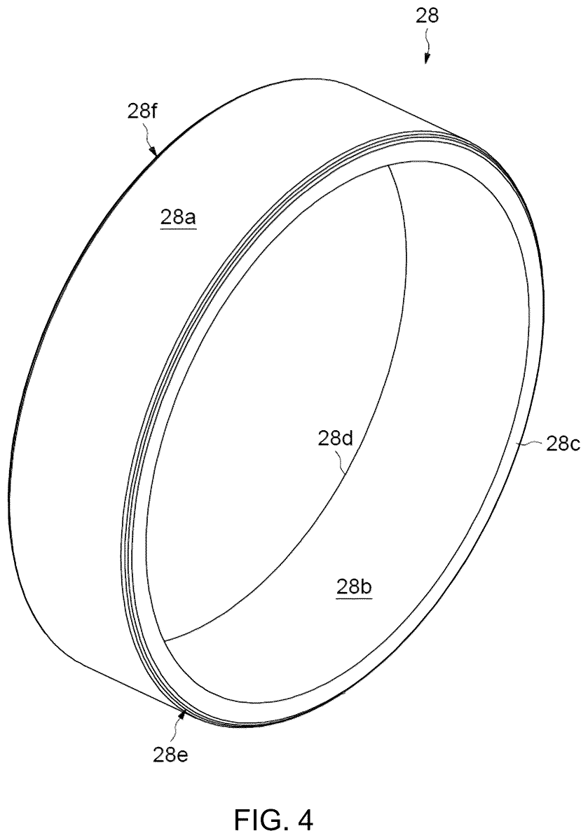

The bearing device also comprises an electrically insulating sleeve 26 mounted on the outer ring 14. The insulating sleeve 26 is mounted on the outer surface 14a of the outer ring 14. The insulating sleeve 26 is secured to the outer ring 14. The insulating sleeve 26 comprises a bushing 28 (shown by itself in FIG. 4) and an insulating insert 30 interposed radially between the outer ring 14 and the bushing 28. The insulating insert 30 is in this case overmolded on the outer ring 14 and on the bushing 28.

The bushing 28 has an annular shape. The bushing 28, of axis X-X′, extends axially. The bushing 28 is formed in one piece in this case. Alternatively, the bushing 28 could be made in a plurality of pieces bearing against one another, for example two identical pieces. The bushing 28 has a cylindrical annular axial outer surface 28a and a cylindrical annular axial bore 28b which is radially on the opposite side from the outer surface 28a. The bore 28b forms the inner surface of the bushing 28. The bore 28b is oriented radially towards the inside, i.e. towards the outer ring 14 and the insulating insert 30. The axis of the bore 28b is coaxial with the axis X-X′.

The bushing 28 also comprises two opposite radial front faces 28c, 28d that axially delimit the bore and the outer surface. The front faces 28c, 28d delimit the axial length of the bushing. The outer surface 28a and the bore 28b delimit the radial thickness of the bushing 28. The outer surface 28a of the bushing delimits the outer surface of the bearing device 10. In other words, the outer surface 28a defines the outside diameter of the bearing device 10.

In the exemplary embodiment illustrated, the front faces 28c, 28d of the bushing are respectively coplanar with the front faces 14c, 14d of the outer ring. Alternatively, other arrangements could be provided. For example, the bushing 28 could have a smaller, or larger, axial dimension and be axially set back from the faces 14c, 14d of the outer ring, or protrude from the faces.

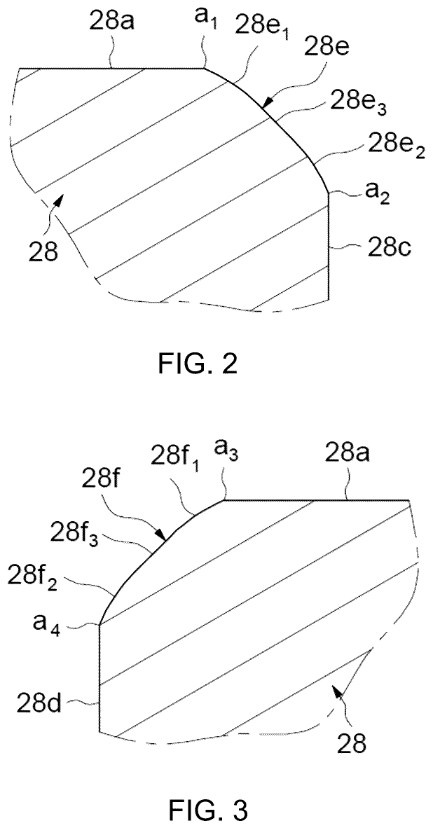

As is illustrated more clearly in FIGS. 2 and 3, the bushing 28 also comprises first and second annular connecting chamfers 28e, 28f that respectively connect the front faces 28c, 28d to the outer surface 28a.

The first connecting chamfer 28e has a first convex surface 28e₁ having a first radius of curvature extending from the outer surface 28a, a second convex surface 28e₂ having a second radius of curvature extending from the front face 28c, and a frustoconical surface 28e₃ between and connecting the first and second convex surfaces 28e₁ and 28e₂.

The first convex surface 28e₁ is connected directly to the outer surface 28a, and the second convex surface 28e₂ is connected directly to the front face 28c. In other words, for the first convex surface 28e₁, there is no additional surface between this first convex surface and the outer surface 28a, and for the second convex surface 28e2, there is no additional surface between this second convex surface and the front face 28c. The frustoconical surface 28e₃ is likewise connected directly to the first and second convex surfaces.

The first convex surface 28e₁ is connected to the outer surface 28a while forming a sharp edge a1 and the second convex surface 28e₂ is connected to the front face 28c while forming another sharp edge a2.

In the exemplary embodiment illustrated, the radii of curvature of the first and second convex surfaces 28e₁ and 28e₂ are the same. Thus, the lengths of these radii of curvature are equal. Alternatively, the lengths of the radii of curvature of the first and second convex surface 28e₁ and 28e₂ could be different.

In an identical way to the first connecting chamfer 28e, the second connecting chamfer 28f has a first convex surface 28f₁ extending from the outer surface 28a, a second convex surface 28f₂ extending from the front face 28d, and a frustoconical surface 28f₃ extending between and connecting the first and second convex surfaces.

The first convex surface 28f₁ is connected directly to the outer surface 28a. The second convex surface 28f₂ is connected directly to the front face 28d. In other words, for the first convex surface 28f₁, there is no additional surface between this first convex surface and the outer surface 28a, and for the second convex surface 28f₂, there is no additional surface between this second convex surface and the front face 28d. The frustoconical surface 28f₃ is likewise connected directly to the first and second convex surfaces.

The first convex surface 28f₁ is connected to the outer surface 28a while forming a sharp edge a3 and the second convex surface 28f₂ is connected to the front face 28c while forming another sharp edge a4.

In the exemplary embodiment illustrated, the radii of curvature of the first and second convex surface 28f₁ and 28f₂ are identical to one another. Thus, the lengths of these radii of curvature are equal. Alternatively, the values of the radii of curvature of the first and second convex surfaces 28f₁ and 28f₂ could be different.

The bushing 28 is made of metal material. Preferably, the bushing 28 is made of steel. The bushing 28 may be obtained from a sheet metal blank by cutting, pressing and roll bending. Alternatively, the bushing 28 may be obtained from a tube or from forged and/or rolled blanks, or by stamping.

In order to manufacture the bushing 28, the following method is followed.

In a first step, a bushing blank is produced that gives it its basic geometry with the rough form of the outer surface 28a, of the bore 28b, of the front faces 28c, 28d and of the connecting chamfers 28e, 28f.

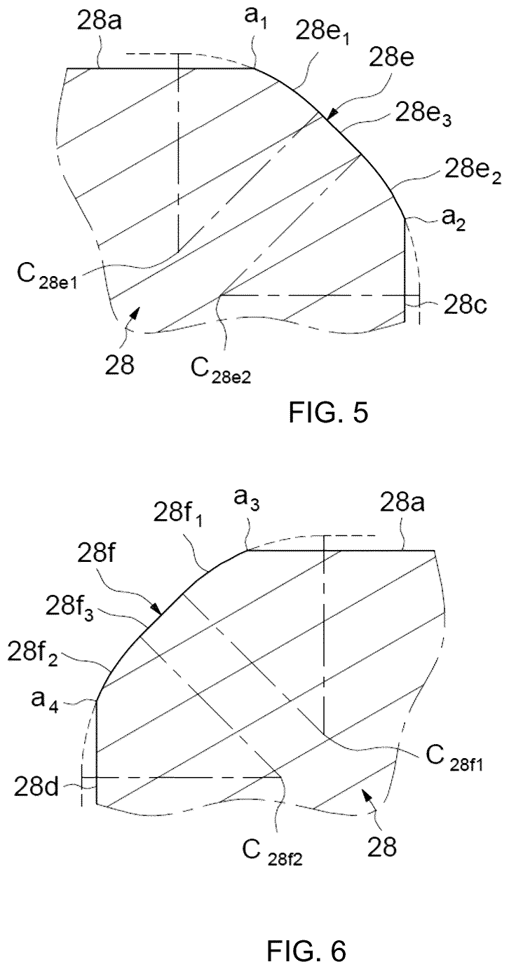

In FIGS. 5 and 6, the outer surface 28a, the connecting chamfers 28e, 28f and the front faces 28c, 28d of the bushing blank is depicted by way of dashed lines. The centers of the first and radii of curvature of the second convex surfaces 28e₁, 28e₂ of the first connecting chamfer 28e bear the respective references C28e₁, C28e₂. The centers of the first and second radii of curvature 28f₁, 28f₂ of the second connecting chamfer 28f bear the respective references C28f₁, C28f₂.

Next, in a following second step, the bushing blank is heat treated in order to give it the required hardness.

Then, in a following third step, the front face 28c of the bushing blank and a part of the second convex surface 28e₂ of the first chamfer that is adjacent to this front face 28c, and the front face 28d of the bushing blank and a part of the second convex surface 28f₂ of the second chamfer that is adjacent to this front face 28d are ground in the radial direction. The sharp edges a2 and a4 are formed during this step.

During this third step, the outer surface 28a of the bushing blank, a part of the first convex surface 28e₁ of the first chamfer that is adjacent to the outer surface 28a, and a part of the first convex surface 28f₁ of the second chamfer that is adjacent to this outer surface 28d are also ground in the axial direction. The sharp edges a1 and a3 are formed during this step.

By way of these grinding steps, the first and second connecting chamfers 28e, 28f of the bushing are truncated. The sharp edge al is offset axially towards the outside, i.e. towards the front face 28c, with respect to the centers C28e₁, C28e₂ of the first and second radii of curvature 28e₁, 28e₂ of the first connecting chamfer.

The sharp edge a2 is offset radially towards the outside, i.e. towards the outer surface 28a, with respect to the centers of the radii of curvature C28e₁, C28e₂ of the first and second radii of curvature 28e₁, 28e₂ of the first connecting chamfer.

In an identical way, the sharp edge a3 is offset axially towards the outside, i.e. towards the front face 28d, with respect to the centers of the radii of curvature C28f₁, C28f₂ of the first and second radii of curvature 28f₁, 28f₂ of the second connecting chamfer, and the sharp edge a4 is offset radially towards the outside, i.e. towards the outer surface 28a, with respect to these centers.

After these grinding steps, the bushing 28 exhibits its final shape and its final dimensions.

The insulating insert 30 is made of electrically insulating material. The insulating insert 30 may, for example, be made of synthetic material, such as PEEK or PA46, or be made of an elastomer material, for example of rubber.

The insulating insert 30 is interposed radially between the outer surface 14a of the outer ring and the bore 28b in the bushing. The insulating insert 30 covers the outer surface 14a of the outer ring. The insulating insert 30 in this case entirely covers the outer surface 14a with regard to the axial and circumferential directions. The insulating insert 30 also covers the grooves 22, 24 in the outer ring. The insulating insert 30 also covers the bore 28b in the bushing. The insulating insert 30 in this case also entirely covers the bore 28b with regard to the axial and circumferential directions.

As indicated above, the insulating insert 30 is in this case overmolded on the outer ring 14 of the bearing and on the bushing 28. The insulating insert 30 is overmolded on the outer surface 14a of the outer ring 14 and on the bore 28b in the bushing 28.

The insulating insert 30 has an annular shape. The insulating insert 30 extends axially. The insulating insert 30 comprises a cylindrical axially extending outer surface 30a, a cylindrical bore 30b radially on the opposite side from the outer surface 30a, and two opposite radially extending front faces 30c, 30d that axially delimit the bore and the outer surface. The front faces 30c, 30d delimit the axial length of the insulating insert 30. The outer surface 30a and the bore 30b delimit the radial thickness of the insulating insert 30. The outer surface 30a is in radial contact with the bore 28b in the bushing. The bore 30b is in radial contact with the outer surface 14a of the outer ring, and with the grooves 22, 24. The bore 30b has a stepped shape.

In the exemplary embodiment illustrated, the faces 14c, 30c, 28c and 14d, 30d, 28d of the outer ring, of the insulating insert and of the bushing are respectively coplanar.

Alternatively, it is possible to provide other arrangements. For example, the insulating insert 30 could have a smaller axial dimension and be axially set back from the faces 14c, 14d of the outer ring. Alternatively, the insulating insert 30 could have a larger axial dimension and protrude axially from the faces 14c, 14d of the outer ring. In this case, the insulating insert 30 may at least partially cover these faces 14c, 14d. In a variant, the insulating insert 30 could at least partially cover the faces 28c, 28d of the bushing.

In another alternative or in combination, the bushing 28 could protrude axially from the insulating insert 30 with respect to the faces 30c and 30d, or be axially set back from these faces.

In the exemplary embodiments illustrated, the first ring 12 of the bearing is the inner ring and the second ring 14, to which the insulating insert 30 is fastened, is the outer ring.

Alternatively, it is possible to provide an opposite disposition, in which the second ring 14, to which the insulating insert 30 is fastened, is the inner ring. In this case, the insulating sleeve is situated in the bore 12a in the inner ring. The insulating insert is then interposed radially between the bore 12a in the inner ring and the outer surface of the bushing. The insulating insert is fastened to the inner ring and at least to the outer surface of the bushing. The bore in the bushing delimits the bore in the bearing device. The connecting chamfer or chamfers in this case connect the front faces of the bushing to the bore.

In the exemplary embodiments described, the bearing of the device is provided with a single row of rolling elements. In a variant, the bearing may be provided with several rows of rolling elements. Furthermore, the rolling bearing may comprise other types of rolling elements than balls, for example rollers. In another variant, the bearing may be a plain bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other, the second ring having a first cylindrical surface and a second cylindrical surface radially spaced from the first cylindrical surface,
a bushing having an axial length and a first cylindrical surface and a second cylindrical surface radially spaced from the first cylindrical surface of the bushing and a first axially facing front face and a second axially facing front face parallel to the first axially facing front face, and
an electrically insulating insert overmolded between and connecting the first cylindrical surface of the bushing and the second cylindrical surface of the second ring,
wherein a first connecting chamfer connects the first cylindrical surface of the bushing to the first front face, the first connecting chamfer comprising a first convex surface extending from the first cylindrical surface of the bushing and having a first radius of curvature, a second convex surface extending from the first front surface and having a second radius of curvature and a first frustoconical surface extending between and connecting the first convex surface and the second convex surface, and
wherein the first convex surface meets the first cylindrical surface at a first sharp edge and the first convex surface meets the first front face of the bushing at a second sharp edge.

2. The bearing device according to claim 1,
wherein a center of the first radius of curvature is spaced from a center of the second radius of curvature.

3. The bearing device according to claim 2,
wherein a length of the first radius of curvature is the same as a length of the second radius of curvature.

4. The bearing device according to claim 1,
wherein a second connecting chamfer connects the first cylindrical surface of the bushing to the second front face, the second connecting chamfer comprising a third convex surface extending from the first cylindrical surface of the bushing and having a third radius of curvature, a fourth convex surface extending from the second front surface and having a fourth radius of curvature and a second frustoconical surface extending between and connecting the third convex surface to the fourth convex surface, and
wherein the third convex surface meets the first cylindrical surface at a third sharp edge and the fourth convex surface meets the second front face of the bushing at a fourth sharp edge.

5. The bearing device according to claim 4,
wherein a center of the third radius of curvature is spaced from a center of the fourth radius of curvature.

6. The bearing device according to claim 5,
wherein a length of the third radius of curvature is the same as a length of the fourth radius of curvature.

7. The bearing device according to claim 6,
wherein the bushing is made of metal.

8. The bearing device according to claim 7,
wherein the bushing is obtained by pressing or by machining.

9. An electric motor comprising:
a housing,
a shaft, and
at least one bearing device according to claim 1 mounted between the housing and the shaft.

10. A method for manufacturing a bushing of a bearing device according to claim 1 comprising the following successive steps:
a step of producing a bushing blank that gives it its basic geometry,
a heat treatment step for giving the bushing blank the required hardness,
a step of radially grinding the first front face of the bushing blank and a part of the second concave radius of the first connecting chamfer which is adjacent to the first front face, and
a step of axially grinding the other surface of the bushing blank and a part of the first concave radius of the first connecting chamfer which is adjacent to the other surface.
